(19) United States
(12) Patent Application Publication
(10) Pub. No.: US 2013/0116962 A1
(43) Pub. Date: May 9, 2013

(54) METHOD AND DEVICE FOR ESTIMATING COOL DOWN IN A SYSTEM

(71) Applicants: Gaute Yddal Vestbostad, Asker (NO); Astrid Kristoffersen, Lier (NO); Lars Artun, Oslo (NO); Nicholas Josep Ellson, Bristol (GB); Inge Wold, Kjeller (NO)

(72) Inventors: Gaute Yddal Vestbostad, Asker (NO); Astrid Kristoffersen, Lier (NO); Lars Artun, Oslo (NO); Nicholas Josep Ellson, Bristol (GB); Inge Wold, Kjeller (NO)

(21) Appl. No.: 13/724,463

(22) Filed: Dec. 21, 2012

Related U.S. Application Data
(63) Continuation of application No. PCT/IB2011/001379, filed on Jun. 17, 2011.

(30) Foreign Application Priority Data
Jun. 21, 2010 (NO) 20100893

(51) Int. Cl. G06F 17/00; G01K 13/00

(52) U.S. Cl. CPC G06F 17/00; G01K 13/00
USPC 702/130

(57) ABSTRACT

Method for estimating cool down in a subsea oil and gas production system, which system includes at least one piping or equipment. The method includes the steps of, at shut down of the production in the system; obtaining data from CFD cool down analysis results for a range of temperatures of production media in the system; obtaining data from a temperature sensor in the system; and estimating the actual coldest temperature in the system from the CFD analysis results obtained based on data from the temperature sensor.

### FIELD OF THE INVENTION

The present invention relates to a method and a device for estimating cool down in a subsea oil and/or gas production or transport systems. These systems typically include equipment such as valve trees, connectors and manifolds but other equipment such as boosting and separator stations may also be included as well as any piping associated with the production systems.

### BACKGROUND OF THE INVENTION

Computational Fluid Dynamics (CFD) is one of the branches of fluid mechanics that uses numerical methods and algorithms to solve and analyze problems that involve fluid flows. Computers are used to perform the millions of calculations required to simulate the interaction of liquids and gases with surfaces defined by boundary conditions. Even with high-speed supercomputers only approximate solutions can be achieved. The fundamental basis of almost all CFD problems is the Navier-Stokes equations, which define any single-phase fluid flow.

An aim of CFD analysis in this application is to determine the insulation requirements so that the operator cool down demands are met. The document COURBOT, A et al. Dalia Field—System Design and Flow Assurance for Dalia Operations. Offshore Technology Conference, 30 Apr.-3 May 2007, Houston Tex., OTC 18540 describes the use of CFD for determining the required insulation thicknesses and to assess the performance of the subsea structures in the Dalia Field. The CFD is thus used in the design stage and not during the actual production stage. The cool down requirements are specified so that when starting from a steady state production temperature, the system should stay above a certain temperature after a given time spent cooling down. These requirements are usually very conservative, with the lowest expected production temperature chosen and cool down analysis performed on a gas filled system. Hence, during normal operation, the cool down performance of the subsea systems should be on the side of the conservative.

Subsea oil and gas production systems have temperature sensors in place today, but there are several limitations that may influence the accuracy and relevance of these sensors. There may also be information hidden in these readings that could be analyzed to detect insulation degradation, changes in the thermal properties due to waxing/fouling etc.

Temperature sensors in for instance valve trees cannot always be located in the position that the thermal analysis has found to be most critical for a cool down. Connectors are usually not instrumented and manifolds have some sensors in selected places. Today there are normally sensors arranged at certain few points in a production or transport system, e.g. from the valve tree to the manifold, measuring the pressures and temperatures. The temperature between these points are however neither measured nor estimated.

Online modelling systems such as EDPM system (eField Dynamic Production Management System) from SPT Group can predict cool down progress, but only on a coarse level, typical scale of hundreds of meters. The cool down progress on a finer detail level is not available today.

After some time the insulation might be degraded or damaged so that thermal insulation is compromised, and this might go undetected.

### SUMMARY OF THE INVENTION

An aim of the present invention is to remedy the drawbacks with the state of the art methods and systems and to provide a method and device for estimating a cool down sequence in a reliable and predictable way to avoid reaching critical temperatures.

This aim is obtained by a method according to the features of the independent claim 1. Preferable embodiments form the subject of the dependent claims 2 to 6.

According to a main aspect of the invention it is characterised by a method for estimating cool down in a subsea oil and/or gas production or transport system, which system comprises at least one equipment or piping, comprising the steps of, at shut down of the production in the system:
obtaining data from CFD cool down analysis results for a range of temperatures of production media in the system;
estimating the actual coldest temperature in the system from the CFD analysis results obtained based on data from said temperature sensor.

According to one aspect of the invention, the method further comprises the step of:
calculating the point of time when a coldest spot in the system will reach a critical temperature.

According to a further aspect of the invention, the CFD cool down analysis comprises performing CFD on components, equipment and piping in the system as well as performing extrapolation and/or interpolation in order to obtain data from a large number of points in the system.

According to another aspect of the invention, the method further comprises the step of:
storing measured temperatures at certain time intervals during cool down sequences in order to obtain data on historical cool down progress.

According to yet another aspect of the invention, the method further comprises the step of:
during a cool down sequence, comparing actual temperatures with stored temperatures for monitoring any difference between previous and actual cool down sequences, in order to detect deterioration of insulation properties of the system.

According to a further aspect of the invention, the method further uses the obtained historical data to calculate new cool down progress for use in future cool down sequence situations.

According to yet a further aspect of the invention, the method further obtains data regarding fluid properties, fluid flow, fluid temperature and pressure of the system.

The aim of the present invention is also obtained by a device according to claims 7 to 12, and computer program product or computer program according to claims 13 and 14 capable of performing the method of the invention as well as a computer readable medium according to claim 15.

There are a number of advantages with the present invention.

With the present invention detailed CFD and equipment/piping knowledge are used to estimate the temperature and cool down between any measuring points in the system.

The invention can correlate the modelled temperature progress to the measured temperature progress so that deviations from design due to for instance degradation or damage to the insulation in the system can be detected.

The invention can further act as adviser with regards to inhibitor dosage or no-touch time. It can thereby provide look-ahead on no-touch time based on current temperature, which might vary due to e.g. uptime, gas-lift rates, phase distribution, well changes, phasing in of new production wells and/or insulation damage/degradation of the system.

These and other aspects of and further advantages with the present invention will become apparent from the following detailed description.

### BRIEF DESCRIPTION OF THE DRAWINGS

With reference to the accompanying drawings a detailed description of preferred embodiments of the invention cited as examples follows below. In the drawings:

FIG. 1 is a schematic view of a system in which the present invention may be performed or implemented, and

FIG. 2 is a flow chart displaying different steps that the present invention may perform.

### DETAILED DESCRIPTION OF THE INVENTION

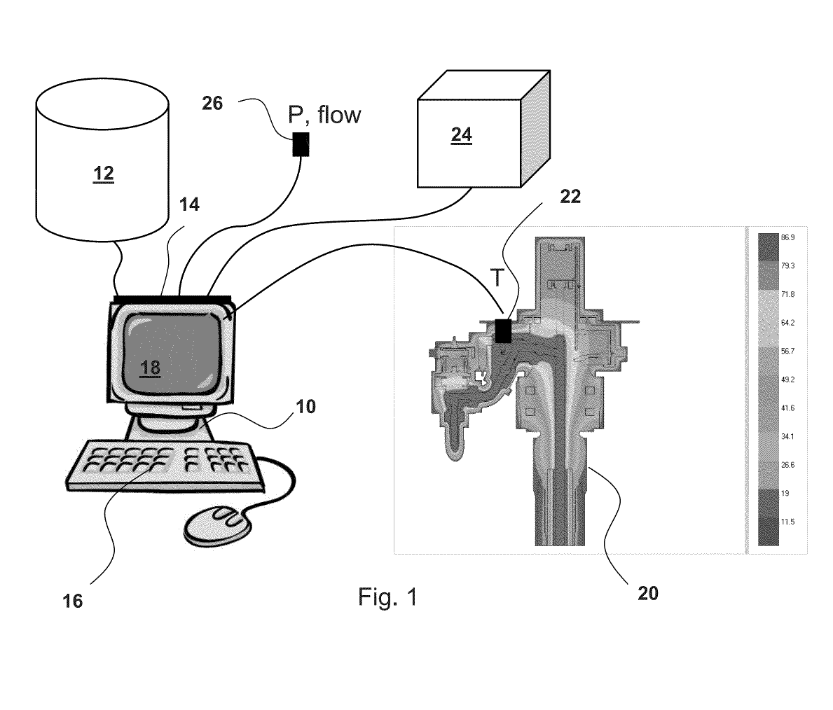

The present invention discloses a thermal or cool down adviser realised by a method and a device for determining cool down of a piping and/or equipment in a subsea system. The method can be provided as a program that can be run on an industrial computer 10, FIG. 1, as well as an ordinary PC. In any event, the computer shall be equipped with a processor capable of running the program, memory storage means 12 for storing the program and data obtained when running the program and data and information regarding the system to be monitored. It is also provided with I/O means 14 to be able to receive and transmit data. Further, the computer may be arranged with a human/machine interface comprising user input means like a keyboard 16, a touch pad or the like as well as a monitor 18 for communicating with the user.

At a specified location in a system 20, such as in a X-mas tree, to be monitored there is a temperature sensor 22. The data from the sensor is continuously or at certain times transmitted to the thermal adviser in the computer via suitable communication means and stored in a memory 12. The thermal adviser could also have access to and be working within the context of an online modelling system 24 such as EDPM system (eField Dynamic Production Management System), as will be described below.

For various reasons the temperature sensor 22 is not necessarily in the spot that cools down fastest, but it is always the coldest spot that is of interest. In oil and gas production it is important to avoid hydrates and also other effects, and these hydrates are created when a certain temperature and pressure is reached. As it is important to know the pressure to foresee when hydrates are created or other unwanted effects occur, the system 20 can also use data measured by a pressure sensor 26.

In order to have full knowledge of the system, CFD simulations of the system as well as of single components, equipment and piping are performed in order to estimate the coldest spot or spots in relation to temperatures at the sensor, comprising e.g. Christmas trees, manifolds, chokes, connectors and the like. As a result of the CFD simulations, a detailed knowledge of the relationship between temperatures at the sensor and at any other point of interest is obtained at all times during steady state as well as cool down. The results of these CFD simulations are also stored in memory storage means or data base 12 used by the thermal adviser. According to the present invention, the results of the CFD simulations are used as basis for extrapolating and/or interpolating between these CFD results. This in turn provides the user with information along any part or structure of the system such that accurate estimations of any cold spots can be obtained.

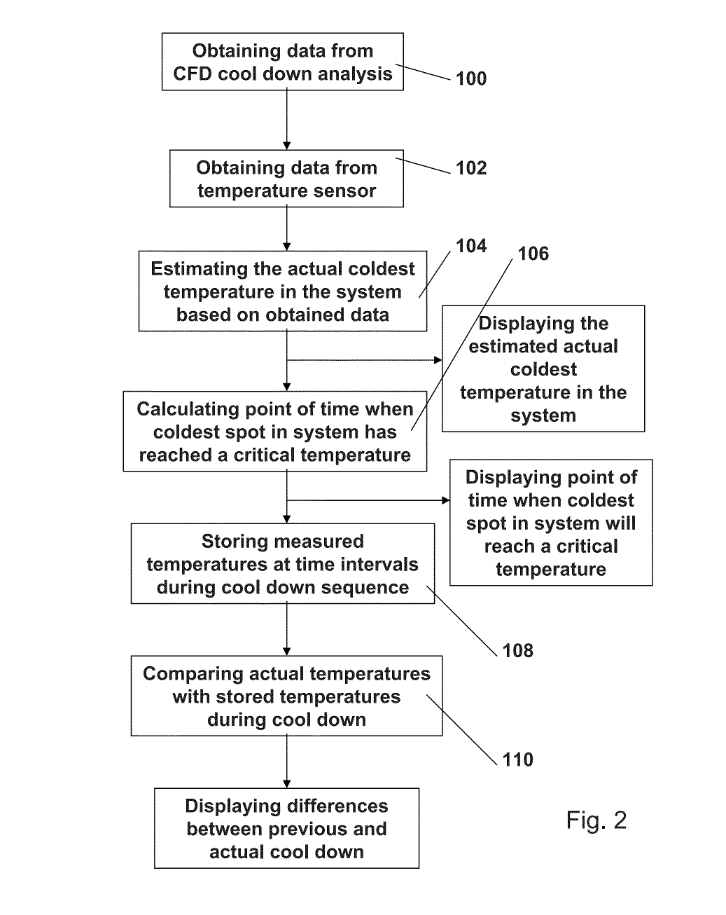

The information from the CFD results and the interpolations and/or extrapolations is used by the thermal adviser to estimate the temperature at any point of interest during the cool down derived from the temperature at the sensor and in particular in the coldest spot in the system. This can be done both for the actual temperature and for a predicted temperature. This is performed in the steps 100, 102 and 104 in FIG. 2.

When the production is shut down, and hence the flow in the system stops, a signal from a control system is transmitted to the thermal or cool down adviser. The thermal adviser will then start to calculate the cool down sequence estimation. The curve for the temperature development in the spot with the temperature sensor has been derived from experience, during earlier cool down situations, or if no experimental data exists, from the CFD analyses and extrapolations and/or interpolations performed during the design of the system. For the prediction of the temperature in this sensor spot, the CFD results are not needed.

If the actual cool down progress is very different from what is estimated, the insulation of the system may be damaged. The thermal adviser will thus also tell the operator about the insulation condition of the system. This is a further advantage with the present invention where information from CFD analyses are used during production for monitoring anomalies in the insulation and changes in the insulation properties due to damage and deterioration.

The CFD cool down analysis results are needed for calculating the coldest spot in the system. Using the CFD analyses results and the temperature in the sensor spot, the temperature in the coldest spot and where it is located can always be estimated. The coldest spot is not always at the same location during the cool down, but this is not of particular interest. The important thing for the operator to know is the lowest temperature in the system, no matter the exact location.

The temperature cool down curve for the spot with the temperature sensor is a function of time. The temperature in the coldest spot can then, for example, be estimated for every minute the next 12 hours, and give the operator the curve for the temperature development for the coldest spot at all times. From this, the time it takes for one location in the system to reach the temperature when hydrates are formed can also be given to the operator.

The thermal adviser will thus monitor the change in temperature from the sensor and can calculate an estimation at what time the temperature will reach a critical value in the coldest spot (step 106 in FIG. 2). All these measures during the cool down sequence may be stored as historical data in e.g. the memory storage means 12 that can be used later (step 108 in FIG. 2).

The thermal adviser could have a number of functionalities:
it will provide a continuous look-ahead on the cold spot temperature of the system that is modelled,
it can respond to changes in the originally assumed data such as
changes in flowing wellhead temperature (FWHT),
changes in the fluid properties such as gas content, water cut, salinity etc. due to well changes or the phasing in of new production wells, giving different starting points for the cool down, different hydrate equibrillium properties etc.
act as an analytical tool to detect changes in predicted cool down progress that is the result of insulation degradation or saturation, damage to coating, growth on coating, waxing/scaling, changes in gas/oil ratio and/or water cut, insulation properties due to aging and/or damage, etc.
new wells might be brought into the system that may have thermo-physical properties that are substantially different from those assumed in the basis of design so that the system deviates significantly from that assumed in the original basis of design cool down criteria. A new cool down criteria can be calculated based on this change and advise for e.g. mono ethylene glycol (MEG) injection may be given.

In order to be able to detect changes in the insulation properties and thus thermal resistance, the thermal adviser makes use of the stored historical data retrieved from the memory. The historical data can provide estimated values that are proportional to the degree of insulation. The design data provides one such value, and after each cool down sequence a new value is generated. The value itself may not be important, but the drift in the values may indicate a change in the thermal properties (step 110 in FIG. 2). This information can be used by the thermal adviser to modify its cool down estimation but can also be provided to the operator of the thermal adviser for suitable actions.

Thermal adviser software provides estimates of temperature by using fundamental thermal relations, either indirectly through processing of different CFD scenarios analysed during the engineering or directly through analysis of the input data and correlation with the equations as will be described further below by way of example.

A part of the thermal adviser software will monitor the temperature progress across an extended distance of equipment, such as a manifold structure, to detect any changes in thermal properties across this structure.

Starting with the one dimensional heat transfer equation:

ρVCᵥdT/dt=ΣᵢUᵢAᵢ(Tᵢ−T)

where

ΣᵢUᵢAᵢ=1/(R_{CONTENT}+R_{STEEL}+R_{INSUL}+R_{OUT})

The thermal resistance in convection heat transfer from internal fluid to pipe (R_{CONTENT}), and also from outside pipe/insulation (R_{OUT}) to surroundings is given by

R=1/(hA)

where

h=convection heat transfer coefficient (hᵢₙ or hₒᵤₜ)

A=the surface area that the fluid or gas is in contact with

The thermal resistance against heat transfer through a medium is given by

R_{M}=ln [(R_{O}/R_{I})/2*π*K_{M}*L]

where
R_{M}=R_{STEEL} OR R_{INSUL}=RESISTANCE IN STEEL OR INSULATION
K_{M}=K_{STEEL} OR K_{INSUL}=THERMAL CONDUCTIVITY IN STEEL AND INSULATION
R_{O}=OUTER RADIUS OF CYLINDER IN THE ACTUAL MEDIUM (STEEL OR INSULATION)
R_{I}=INNER RADIUS OF CYLINDER IN THE ACTUAL MEDIUM (STEEL OR INSULATION)
L=LENGTH OF CYLINDER

The measured temperature progress is compared to the calculated temperature progress that may be determined from the general energy balance equation as given below.

$${\frac{d }{d t} [ {ρ}_{fluid} {C}_{v} ( {T}_{f} - {T}_{ref} ) {A}_{in} d Z ]}_{fluids} + \sum {\frac{d }{d t} [ {ρ}_{layer} {C}_{p} ( {T}_{i} - {T}_{ref} ) {A}_{layer} d Z ]}_{solids} ∝ ( {U}_{eff} A ( {T}_{f} - {T}_{env} ) )$$

where

ρ: density of fluid or solid

Cᵥ: heat capacity at constant volume

C_{P}: heat capacity at constant pressure

T: temperature

T_{ref}: reference temperature for thermodynamic calculation

A: surface area

Z: radial thickness

U_{eff}: total heat transfer coefficient

subscripts:

fluid, f: fluid property

ref: reference temperature for thermodynamic calculation

in: inner wall property (area)

layer: property of distinct material layer

solids: solid properties

env: environment/ambient condition

To solve this equation the thermal adviser software will thus be provided with the fluid properties, fluid flow, fluid temperature and pressure. In the case where the thermal adviser is working within the context of the online modelling system 24 such as EDPM system (eField Dynamic Production Management System), all these data are available through the EDPM system interface. If the thermal adviser is a standalone application, it will have to work on a combination of parameters like system geometry (diameters, elevation, bends etc), material properties and ambient conditions and data readings from flow meters, pressure sensors 26 and temperature sensors 22.

The thermal adviser could also be successfully integrated with other software packages that perform flow calculations.

When the energy balance equation has been solved and the other factors that are inputs to the equation are known, an adjusted total heat transfer coefficient, or U value (in W/m²K) can be derived.

The following example illustrates how the thermal adviser will calculate during one cool down:

For this example it is supposed that CFD results for normal production conditions at 80° C., and then CFD results for 70, 60, 50, 40, 30, 20° C. are available. Results for any lower temperatures are not of interest in this case. The temperatures for which the CFD results are defined, are valid for one specific spot in the analysed area of the system, where a temperature sensor is located. The CFD results can be 2-D images as shown in FIG. 1, but more often it will be 3-D representations of the CFD results.

At a certain time, the temperature in the sensor spot is 67° C., and the temperature in the coldest spot in the system at this time is to be found. The adviser then has to interpolate between the CFD results for 60 and 70° C. to create a “chart” for 67° C. It then uses the interpolated results to estimate the temperature in the coldest spot (and can also give the location) when the temperature in the sensor spot is 67° C.

All numbers in this example are purely made up for illustration purpose. Numbers will also vary with the different systems analysed.

The present invention may be implemented as software, hardware, or a combination thereof. A computer program product or a computer program implementing the method or a part thereof comprises software or a computer program run on a general purpose or specially adapted computer, processor or microprocessor. The software includes computer program code elements or software code portions that make the computer perform the method. The program may be stored in whole or part, on, or in, one or more suitable computer readable media or data storage means such as a magnetic disk, CD-ROM or DVD disk, hard disk, magneto-optical memory storage means, in RAM or volatile memory, in ROM or flash memory, as firmware, or on a data server. Such a computer program product or a computer program can also be supplied via a network, such as Internet.

It is to be understood that the embodiments described above and illustrated in the drawings are to be regarded only as non-limiting examples of the present invention and may be modified in many ways within the scope of the appended claims.

1. A method for estimating cool down in a subsea oil and/or gas production system, which system comprises at least one equipment or piping, comprising the steps of, at shut down of the production in the system:
obtaining data from CFD cool down analysis results for a range of temperatures of production media in the system;
obtaining data from a temperature sensor in the system; and
estimating the actual coldest temperature in the system from the CFD analysis results obtained based on data from said temperature sensor.

2. The method according to claim 1, wherein it further comprises the step of:
calculating the point of time when a coldest spot in the system will reach a critical temperature.

3. The method according to claim 1, wherein the CFD cool down analysis comprises performing CFD on components, equipment and piping in the system as well as performing extrapolation and/or interpolation in order to obtain data from a large number of points in the system.

4. The method according to claim 1, wherein it further comprises the step of:
storing measured temperatures at certain time intervals during cool down sequences in order to obtain data on historical cool down progress.

5. The method according to claim 4, wherein it further comprises the step of:
during a cool down sequence, comparing actual temperatures with stored temperatures for monitoring any difference between previous and actual cool down sequences, in order to detect deterioration of insulation properties of the system.

6. The method according to claim 4, wherein it further comprises the step of:
using the obtained historical data to calculate new cool down progress for use in future cool down sequence situations.

7. The method according to claim 1, wherein it further comprises the step of:
obtaining data regarding fluid properties, fluid flow, fluid temperature and pressure of the system.

8. A device for estimating cool down in a subsea oil and/or gas production system, which system comprises at least one equipment or piping, comprising, at shut down of the production in the system:
means for obtaining data from CFD cool down analysis results for a range of temperatures of production media in the system;
means for obtaining data from a temperature sensor in the system;
means for estimating the actual coldest temperature in the system from the CFD analysis results obtained based on continuous data from said temperature sensor.

9. The device according to claim 8, wherein it further comprises means for calculating the point of time when a coldest spot in the system will reach a critical temperature.

10. The device according to claim 8, wherein it further comprises means for storing measured temperatures at certain time intervals during cool down sequences in order to obtain historical cool down progress.

11. The device according to claim 10, wherein it further comprises means for, during a cool down sequence, comparing actual temperatures with stored temperatures for monitoring any differences between previous and actual cool down sequences, in order to detect deterioration of insulation properties of the system.

12. The device according to claim 10, wherein it further comprises means for using the obtained historical data to calculate new cool down progress for use in future cool down sequence situations.

13. The device according to claim 8, wherein it further comprises means for obtaining data regarding fluid properties, fluid flow, fluid temperature and pressure of the system.

14. A computer program product comprising computer code means and/or software code portions for making a processor perform the steps of claim 1.

15. The computer program product according to claim 14 supplied via a network, such as Internet.

16. The computer readable medium containing a computer program product according to claim 14.
